(19) United States
(12) Patent Application Publication
(10) Pub. No.: US 2023/0166725 A1
(43) Pub. Date: Jun. 1, 2023

(54) OPTIMIZING PARKING LOCATIONS

(71) Applicant: GM Global Technology Operations LLC, Detroit, MI (US)

(72) Inventors: Omer Tsimhoni, Bloomfield Hills, MI (US); Claudia Goldman-Shenhar, Mevasseret Zion (IL); Joseph F. Szczerba, Grand Blanc, MI (US); Jeremy A. Salinger, Southfield, MI (US); Roy J. Mathieu, Rochester Hills, MI (US)

(21) Appl. No.: 17/539,364

(22) Filed: Dec. 1, 2021

(51) Int. Cl. B60W 30/06; G06F 3/0482; G06F 3/14; G08G 1/14; B60W 50/14

(52) U.S. Cl. CPC B60W 30/06; G06F 3/0482; G06F 3/14; G08G 1/143; B60W 50/14; B60W 2556/10; B60W 2540/215; B60W 2050/146; G08G 1/145

(57) ABSTRACT

A system for selecting an optimized parking location for a vehicle includes a data processor, a plurality of sensors within the vehicle, and a user model based on historical data of parking events for the vehicle, the data processor is adapted to collect parking preferences for a driver of the vehicle, identify a destination of the vehicle, identify a current location of the vehicle, collect data from a plurality of sensors within the vehicle, collect data from external sources and create a list of potential parking spaces, access the user model, rank the potential parking spaces based on the parking preferences of the driver, the data from external sources and the user model, and provide an output based on parking preferences for the driver of the vehicle and the user model.

### INTRODUCTION

The present disclosure relates to a system and method for selecting optimized parking spaces based on a driver's preferences.

In-vehicle information systems have become commonplace in vehicles such as automobiles, trucks, sport utility vehicles, etc. The information systems typically provide navigation information, entertainment information (e.g., information associated with the radio, CD player, DVD player, etc.), and other information of the vehicle. In some instances, the information systems may be used to configure user preferences. For example, the information systems present options to the user and the user indicates their preferences by selecting one or more of the options.

A driver of a vehicle may experience anxiety and uncertainty when searching for an optimal parking spot due to lack of information about possible empty spaces that are available to them, and which may better satisfy their own preferences regarding parking complexity and time to destination. Some parking facilities provide guidance to customers about where parking spots are available. These may include signs that indicate the number of spots available in the entire facility, or on each floor. They may also have a light or other indicator near each parking space and visible from a distance that shows whether the space is available. Current automated driving systems do not include searching for and choosing a parking location adaptive to a driver's preferences. Further, current automated driving systems do not explain their choices.

Thus, while current systems and methods achieve their intended purpose, there is a need for a new and improved system and method to select an optimal parking space by adapting selection of a parking space to a drivers' preferences and contextual information, interacting with the driver regarding the selection of parking space, and explaining the reasoning behind parking space selections.

### SUMMARY

According to several aspects of the present disclosure, a method of selecting an optimized parking location for a vehicle includes collecting, with a data processor, parking preferences for a driver of the vehicle, identifying, with the data processor, a destination of the vehicle, identifying, with the data processor, a current location of the vehicle, collecting, with the data processor, data from a plurality of sensors within the vehicle, collecting, with the data processor, data from external sources and creating a list of potential parking spaces, accessing, with the data processor, a user model based on historical data of parking events for the vehicle, ranking, with the data processor, the potential parking spaces based on the parking preferences of the driver, the data from external sources and the user model, and providing, with the data processor, an output based on parking preferences for the driver of the vehicle and the user model.

According to another aspect, the collecting, with the data processor, of parking preferences for the driver of the vehicle further includes collecting, with the data processor, via a driver interface, one of a first selection preference, a second selection preference and a third selection preference.

According to another aspect, the providing, with the data processor, the output based on parking preferences for the driver of the vehicle and the user model further includes, sending, with the data processor, instructions to a vehicle controller to automatically park the vehicle in a highest ranked potential parking space when the driver of the vehicle has selected, via the driver interface, the first selection preference.

According to another aspect, the providing, with the data processor, the output based on parking preferences for the driver of the vehicle and the user model further includes displaying, with the data processor, via the driver interface, a plurality of ranked potential parking spaces, collecting, with the data processor, via the driver interface, a selection of one of the ranked potential parking spaces by the driver and a selection of one of automated parking and manual parking, and sending, with the data processor, instructions to the vehicle controller to automatically park the vehicle in a selected one of the plurality of ranked potential parking spaces when the driver of the vehicle has selected, via the driver interface, the second selection preference and automated parking.

According to another aspect, the providing, with the data processor, the output based on parking preferences for the driver of the vehicle and the user model further includes sending, with the data processor, instructions to the vehicle controller to allow the driver of the vehicle to manually park the vehicle in the selected one of the plurality of ranked potential parking spaces when the driver of the vehicle has selected, via the driver interface, the second selection preference and manual parking.

According to another aspect, the providing, with the data processor, the output based on parking preferences for the driver of the vehicle and the user model further includes displaying, with the data processor, via the driver interface, the plurality of ranked potential parking spaces when the driver of the vehicle has selected, via the driver interface, the third selection preference.

According to another aspect, the displaying, with the data processor, via the driver interface, the plurality of ranked potential parking spaces further includes, displaying, with the data processor, via the driver interface, an explanation of the ranking of the plurality of ranked potential parking spaces.

According to another aspect, the displaying, with the data processor, via the driver interface, an explanation of the ranking of the plurality of potential parking spaces further includes, displaying, with the data processor, via the driver interface, a comparison of parking characteristics of each of the plurality of potential parking spaces to user preferences based on parking preferences for the driver of the vehicle, the data from external sources and the user model.

According to another aspect, the method further includes updating, with the data processor, the user model based on inputs collected by the data processor, via the driver interface, and which one of the plurality of potential parking spaces is ultimately selected.

According to another aspect, the method further includes creating the list of potential parking spaces and the ranking, with the data processor, the potential parking spaces based on the parking preferences of the driver and the user model at a pre-determined interval as the vehicle moves toward the destination.

According to another aspect, the ranking, with the data processor, the potential parking spaces based on the parking preferences of the driver, the data from external sources and the user model further includes, assigning a value to each one of the potential parking spaces based on how closely each one of the potential parking spaces satisfies the parking preferences of the driver.

According to another aspect, the ranking, with the data processor, the potential parking spaces based on the parking preferences of the driver, the data from external sources and the user model further includes, calculating a probability that each one of the potential parking spaces will be empty at a time when the vehicle will arrive at such parking space.

According to several aspects of the present disclosure, a system for selecting an optimized parking location for a vehicle includes a data processor, a plurality of sensors within the vehicle, and a user model based on historical data of parking events for the vehicle, the data processor adapted to collect parking preferences for a driver of the vehicle, identify a destination of the vehicle, identify a current location of the vehicle, collect data from a plurality of sensors within the vehicle, collect data from external sources and create a list of potential parking spaces, access the user model, rank the potential parking spaces based on the parking preferences of the driver, the data from external sources and the user model, and provide an output based on parking preferences for the driver of the vehicle and the user model.

According to another aspect, the system further includes a driver interface, wherein the data processor is adapted to collect parking preferences for the driver of the vehicle via the driver interface, the parking preferences being one of a first selection preference, a second selection preference and a third selection preference.

According to another aspect, the system further includes a vehicle controller, wherein, when the driver of the vehicle has selected the first selection preference, the output provided by the data processor comprises instructions, sent to the vehicle controller, to automatically park the vehicle in a highest ranked potential parking space.

According to another aspect, the data processor is further adapted to display, via the driver interface, a plurality of ranked potential parking spaces, and collect, via the driver interface, a selection of one of the ranked potential parking spaces by the driver and a selection of one of automated parking and manual parking, wherein, when the driver of the vehicle has selected the second selection preference and automated parking, the output provided by the data processor comprises sending instructions to the vehicle controller to automatically park the vehicle in a selected one of the plurality of ranked potential parking spaces, when the driver of the vehicle has selected the second selection preference and manual parking, the output provided by the data processor comprises sending instructions to the vehicle controller to allow the driver of the vehicle to manually park the vehicle in the selected one of the plurality of ranked potential parking spaces, and when the driver of the vehicle has selected the third selection preference, the output provided by the data processor comprises displaying, via the driver interface, the plurality of ranked potential parking spaces.

According to another aspect, the data processor is further adapted to display, via the driver interface, an explanation of the ranking of the plurality of ranked potential parking spaces by displaying a comparison of parking characteristics of each of the plurality of potential parking spaces to user preferences based on parking preferences for the driver of the vehicle, the data from external sources and the user model.

According to another aspect, the data processor is adapted to update the user model based on inputs collected by the data processor, via the driver interface, and which one of the plurality of potential parking spaces is ultimately selected.

According to another aspect, the data processor is adapted to repeat creating the list of potential parking spaces and ranking the potential parking spaces at a pre-determined interval as the vehicle moves toward the destination.

According to another aspect, the data processor is adapted to rank the potential parking spaces based on the parking preferences of the driver, the data from external sources and the user model by assigning a value to each one of the potential parking spaces based on how closely each one of the potential parking spaces satisfies the parking preferences of the driver, and calculating a probability that each one of the potential parking spaces will be empty at a time when the vehicle will arrive at such parking space.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system according to an exemplary embodiment of the present disclosure;

FIG. 2 is an example of a display on a driver interface allowing the driver to choose between first, second and third selection preferences;

FIG. 3 is an example of a display on a driver interface presenting a list of ranked parking spaces to the driver; and

FIG. 4 is a flow chart illustrating a method of operating the system of FIG. 1.

### DETAILED DESCRIPTION

The following description is merely exemplary in nature and is not intended to limit the present disclosure, application, or uses.

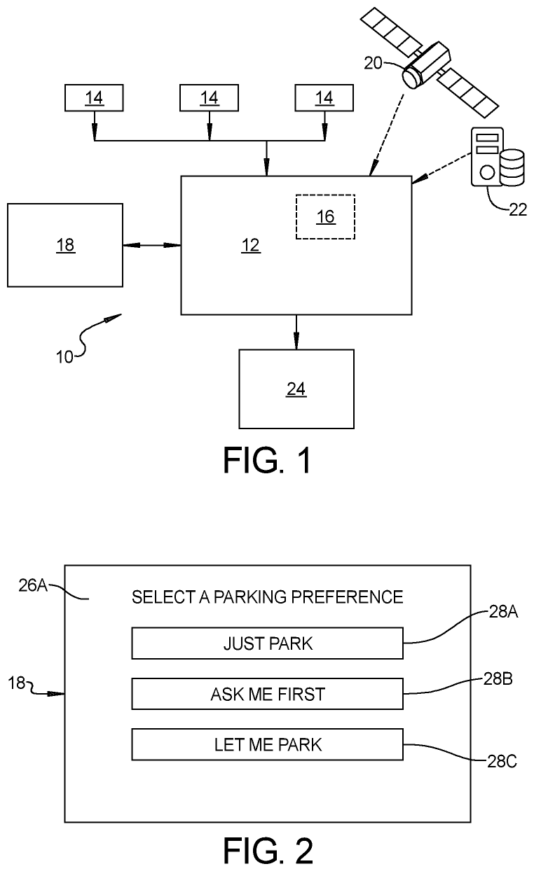

Referring to FIG. 1, a system 10 for selecting an optimized parking location for a vehicle, includes a data processor 12, a plurality of sensors 14 within the vehicle, and a user model 16. The data processor 12 is a non-generalized, electronic control device or CPU having a preprogrammed digital computer or processor, memory or non-transitory computer readable medium used to store data such as control logic, software applications, instructions, computer code, data, lookup tables, etc., and a transceiver and input/output ports. Computer readable medium includes any type of medium capable of being accessed by a computer, such as read only memory (ROM), random access memory (RAM), a hard disk drive, a compact disc (CD), a digital video disc (DVD), or any other type of memory. A “nontransitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. Thus, the term “data processor,” as used herein, is not literally restricted to a single CPU. Moreover, the data processor 12 may itself comprise a network of one or more computers, as can any other device referred to as a “computer” herein.

The plurality of sensors 14 gather input of various vehicle conditions and data from one or more vehicle systems. Such data may include failure of system modes, operating limits of an individual vehicle system component, and reconfiguration parameters associated with vehicle systems that allow for user interface. The plurality of sensors 14 also gathers environmental inputs. The plurality of sensors 14 can include temperature sensors, traffic sensors, road type (e.g., highway, urban) sensors, weather (e.g., rain) sensors, occupancy sensors, external cameras, internal cameras, Lidar/Radar, brake sensors, steering sensors, throttle sensors, speed sensors, vehicle switches, personal devices, HMI interactions, microphones, and the like.

As provided, the sensors 14 can measure any of a wide variety of phenomena or characteristics. Sensors can measure, as further example, ignition position or states of the vehicle, whether the vehicle is being turned off or on, whether or to what degree the vehicle is within a distance of a location, a type of weather (e.g., rain), a level of weather (e.g., amount of rain), an outside temperature, an outside humidity, an outside wind temperature, a cabin temperature, a vehicle speed, occupancy of a seat in the vehicle, weight of an occupant of a seat in the vehicle (e.g., to identify occupancy and distinguish between a child and adult), who is in the cabin (e.g., as identified by the presence of auxiliary devices that are specific to a user), vehicle state (e.g., amount of gas in the tank, cabin temperature, amount of oil), driver state (e.g., how long the driver has been driving and how they are driving (e.g., erratically), general conditions (e.g., weather, temperature, day, time), driving conditions (e.g., road type, traffic), and the like.

The user model 16 is based on historical data of past parking events for the driver, the vehicle, or both. The user model 16 may be based on historical data of past parking events for the vehicle itself, or the user model 16 may be customized for a particular driver. In such an instance, the user model 16 for a particular driver may be stored on a cloud-based database, wherein when the driver uses a particular vehicle, the driver's unique user model 16 is downloaded to the vehicle. The user model 16 is created by collecting data from past parking events and using past behavior to predict future behavior. The user model 16 contains information on the characteristics of chosen parking spaces, and other factors that contribute to the selection of a parking space. The user model 16 will predict what features are desirable in a parking space for the present conditions. A driver specific user model 16 can distinguish between driving patterns for the same user based on the vehicle that is being driven. For example, the driver specific user model 16 would distinguish when the driver is driving a vehicle that the driver uses exclusively for work, and when the driver is driving a vehicle that is used almost exclusively for traveling with the driver's family. The user model 16 is created/updated by the data processor 12 and stored within the data processor 12, in the case of a vehicle unique user model 16, or within a remote cloud-based data base, in the case of a driver specific user model 16. Further, the user model 16 may be stored within a mobile app on a device belonging to the driver, wherein the user model 16 and the system 10 may have access to the driver's calendar, which may aid the user model in predicting current preferences, such as when the calendar indicates the driver is late for a meeting, thus prioritizing close/easy parking, despite cost.

The data processor 12 is adapted to collect parking preferences for a driver of the vehicle. In an exemplary embodiment, the system 10 includes a driver interface 18. The data processor 12 is adapted to collect parking preferences for the driver of the vehicle via the driver interface 18. The data processor 12 receives parking preferences from the driver interface 18 by way of input/output ports within the data processor 12. In various embodiments, the driver interface 18 can include, but is not limited to, a speech system and/or a display system. As can be appreciated, in various embodiments, other driver interface 18 types that receive information about a driver's preferences from the driver may be implemented within the vehicle or may be implemented separate from the vehicle and may communicate with the data processor 12 (e.g., smartphones, tablets, remote servers, etc.).

In various embodiments, a speech-based driver interface 18 presents preference options to the driver by way of a spoken dialog and receives preference information from the driver in the form of recorded user speech. The data processor 12 manages the spoken dialog generated by the speech-based driver interface to obtain the preference information. The spoken dialog can be managed based on the context of the dialog. The current context may be identified based on context information received from the vehicle or other systems associated with the vehicle. The context information can be provided by, for example, other control modules in the vehicle (e.g., body control modules, engine control modules transmission control modules, infotainment control modules, etc.), the plurality of sensors 14, and/or a communication bus or other communication means of the vehicle. The speech-based driver interface 18 processes the recorded user speech to identify the preference information and provides the preference information to the data processor.

In various embodiments, the driver interface 18 presents preference options to the driver by displaying a graphical user interface on a display and receives the driver parking preferences from the driver in the form of input signals received from a driver's interaction with sensors and/or switches of the display. The data processor 12 manages the graphical user interface generated by the driver interface 18 to obtain the preference information. The graphical user interface can be managed based on the context of the display. The current context may be identified based on context information received from the vehicle or from other systems associated with the vehicle. The driver interface 18 processes the input signals to identify the preference information and provides the preference information to the data processor 12. Alternatively, the driver interface 18 may communicate with a personal device of the driver or a mobile app, wherein, driver parking preferences may be communicated to the data processor 12, even when a driver/user of the vehicle is not within the vehicle.

The data processor 12 is adapted to identify a destination of the vehicle. The data processor 12 accesses information from in-vehicle systems, such as a navigation system to determine a final destination of the vehicle. The data processor 12 is also adapted to identify a current location of the vehicle. The data processor 12 receives information from a GPS system 20 to determine the current location of the vehicle. The data processor 12 is also adapted to collect data from the plurality of sensors 14 within the vehicle to determine vehicle and environmental conditions around the vehicle.

The data processor is further adapted to collect data from external sources 22 and create a list of potential parking spaces for the vehicle. The data processor 12 collects data from external sources 22, such as sensor/camera data from parking infrastructures and information about nearby parking availability from databases maintained by individual parking infrastructures and transportation groups, such as the Department of Transportation (DOT). In addition, the external sources 22 may include other vehicles, wherein, through crowdsourcing, information can be obtained directly from other vehicles through a network communication. For example, when a vehicle leaves a parking space, it communicates that information to nearby vehicles through a vehicle-to-vehicle network to inform other vehicles of the availability of the recently vacated parking space. The data processor 12 includes a transceiver which allows the data processor 12 to communicate wirelessly with remote databases of external sources 22 over a WLAN, 4G or 5G network, or the like.

The data processor 12 is further adapted to access the user model 16 and rank the potential parking spaces based on the parking preferences of the driver, the data from external sources 22 and the user model 16, and to provide an output based on parking preferences for the driver of the vehicle and the user model 16.

The data processor 12 is adapted to rank the potential parking spaces based on the parking preferences of the driver, the data from external sources 22 and the user model 16 by assigning a value to each one of the potential parking spaces based on how closely each one of the potential parking spaces satisfies the parking preferences of the driver. For example, according to the user model 16, whenever it is raining, the vehicle is parked in a covered parking space. The user model 16 will use that information to predict that the driver of the vehicle will prefer a covered parking space when it is raining and assign a higher value to covered parking spaces whenever it is raining. In another example, the user model 16 indicates that on weekdays, when the driver of the vehicle is traveling alone to work in the morning, the vehicle is typically parked in less expensive parking spaces, but, on weekends, when the driver of the vehicle is traveling with passengers, later in the day, the vehicle is typically parked in locations that are closer to the final destination, regardless of the cost. Thus, if the driver of the vehicle is going to dinner with a companion on a Saturday evening, the data processor 12 will assign a higher value to parking spaces that are nearest to the final destination.

When ranking the potential parking spaces, the system 10 optimizes based on a perspective from the driver, taking into consideration the weather, distance that the driver may be willing to walk and how long the vehicle will need to be parked there. The system 10 further optimizes based on a perspective from the vehicle, taking into consideration elements such as distance to the final destination, distance to a parking space, speed and maneuverability of the vehicle, and does the vehicle require charging while parked. Finally, the system 10 further optimizes based on a perspective from the parking space, taking into consideration elements such as complexity of the parking space (structure, street, difficulty to exit, etc.), price, probability of space being empty, time allowed to park, permit requirements, and possible next tasks for the vehicle. For example, an autonomous vehicle may need to travel autonomously to a more distant parking space, or may need to continue on to satisfy a task, such as, taking another passenger to a different location, deliver a package to a different location, etc. Such next tasks may affect where the vehicle drops a user and the parking space ultimately selected.

A first step in ranking or scoring a list of potential parking spaces includes identifying parking spaces for which information is known to identify parking spaces that fit the priorities established by the user model 16 and are close enough to the vehicle to be selected, if the space is empty. For example, when computing a score for a given parking space, Pᵢ, calculate the variables:

Pᵢ location: can be mapped to a value between 0-1, where 1 represents closer parking and lower numbers represent more distant parking;

Pᵢ price: can be mapped to a value between 0-1, where 1 represents expensive parking and lower numbers are for cheaper parking; and

Pᵢ complexity: assume a value between 0-1, where 1 represents the most complicated parking.

From the user model 16, with preferences about this parking space for current time and destination, get a probability between 0 to 1 for the user to like parking at Pᵢ, then:

score(Pᵢ)=User value(Pᵢ)*(−(complexity(Pᵢ)+price(Pᵢ))).

From the user model 16, get a binary value for 1, indicating that the driver would want to park at parking space Pᵢ, or a value of 0 otherwise, then:

score(Pᵢ)=User value(Pᵢ)−(complexity(Pᵢ)+price(Pᵢ)).

The distance to the final destination can be added here as well, but it is currently considered in the time it would take for the driver to walk to the final destination.

Additionally, a second step in ranking or scoring potential parking spaces includes a probabilistic analysis, wherein the data processor 12 will calculate a probability that each one of the potential parking spaces will be empty at a time when the vehicle will arrive at such parking space. For example, assuming a database with parking options is available to the system 10 and that an occupancy distribution model has been computed such that for any time and date, the probability of finding an empty spot at a particular parking location can be retrieved. Using such data, the data processor 12 determines that certain parking structures are generally full or close to full during specific times, such as, during working hours for a parking structure near an office building, and during early evening hours for a parking structure near a restaurant district. When ranking the potential parking spaces, the data processor 12 calculates a probability that a parking space within a particular parking structure will be available at an estimated time of arrival. If data suggests that such a parking space has a low probability of being available, the data processor 12 will assign a lower score to such parking space. Alternatively, the system 10 may communicate with the parking facility to reserve a parking space, thus eliminating the probabilistic element of ranking/scoring the potential parking spaces, and allowing the system 10 to guarantee that such parking space will be empty when the vehicle arrives.

At least some of the parking preference options that are presented to the driver via the driver interface 18 are multi-dimensional (i.e., having at least two options that are related by a condition or having at least one fuzzy valued option). In an exemplary embodiment, the driver interface 18 accepts a selection by the driver of one of a first selection preference, a second selection preference and a third selection preference. Referring to FIG. 2, an example of a display screen 26A for a driver interface 18 is shown, including a first touch screen icon 28A, for choosing the first selection preference, a second touch screen icon 28B, for choosing the second selection preference, and a third touch screen icon 28C, for choosing the third selection preference.

The first selection preference may be classified as “Just Park”. In an exemplary embodiment, the system 10 further includes a vehicle controller 24. When the driver of the vehicle has selected the first selection preference, the output provided by the data processor 12 comprises instructions, sent to the vehicle controller 24, to automatically park the vehicle in a highest ranked potential parking space. For example, in an autonomous vehicle, the driver may wish to allow the system 10 to select the highest ranked parking space and the vehicle controller 24 will maintain control of the vehicle until the vehicle is parked in the highest ranked parking space.

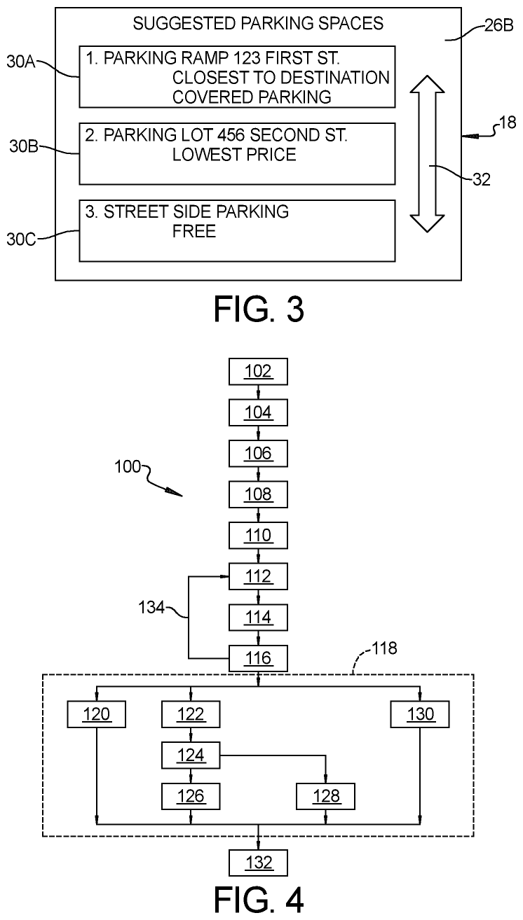

The second selection preference may be classified as “Ask Me First”. In an exemplary embodiment, the data processor 12 is further adapted to display, via the driver interface 18, the plurality of ranked potential parking spaces, and to collect, via the driver interface 18, a selection of one of the ranked potential parking spaces by the driver and a selection of one of automated parking and manual parking. The data processor 12 displays the ranked parking spaces in decreasing value. For example, the driver interface 18 displays the three highest ranked parking spaces so the driver can select one of the three highest ranked parking spaces. If the driver desires, he can scroll down to see additional lower ranked parking spaces. Referring to FIG. 3, an example of a display screen 26B for a driver interface 18 is shown, including a list of ranked potential parking spaces. As shown, the list includes three touch screen icons 30A, 30B, 30B, one for each of the three highest ranked parking spaces. The display screen 26B further includes a touch screen slide bar 32 to allow the driver to scroll down through the list of ranked parking spaces to see lower ranked parking spaces.

When the driver of the vehicle has selected the second selection preference and automated parking, the output provided by the data processor 12 comprises sending instructions to the vehicle controller 24 to automatically park the vehicle in a selected one of the plurality of ranked potential parking spaces. When the driver of the vehicle has selected the second selection preference and manual parking, the output provided by the data processor 12 comprises sending instructions to the vehicle controller 24 to allow the driver of the vehicle to manually park the vehicle in the selected one of the plurality of ranked potential parking spaces. For example, in an autonomous vehicle, the vehicle controller 24 will dis-engage autonomous driving, allowing the driver of the vehicle to take control of the vehicle and manually park the vehicle in the selected parking space.

The third selection preference may be classified as “Let Me Park”. When the driver of the vehicle has selected the third selection preference, the output provided by the data processor 12 comprises displaying, via the driver interface 18, the plurality of ranked potential parking spaces. No selection of a parking space is requested. The driver of the vehicle simply refers to the list of ranked parking spaces as a reference to decide where to park the vehicle.

In an exemplary embodiment, the data processor 12 is further adapted to display, via the driver interface 18, an explanation of the ranking of the plurality of ranked potential parking spaces by displaying a comparison of parking characteristics of each of the plurality of potential parking spaces to user preferences based on parking preferences for the driver of the vehicle, the data from external sources 22 and the user model 16.

For example, the data processor 12 may provide an explanation that the highest ranked parking space in the list of ranked parking spaces is ranked #1 because it is raining and that particular parking space is in a covered parking structure and is closest to the destination, as shown in FIG. 3. In another example, the data processor may provide an explanation that the highest ranked parking space in the list of ranked parking spaces is ranked #1 because the weather outside is clear, and even though other spaces in the list are closer, the #1 ranked parking space has the lowest cost. The reasoning for the ranking, and the explanation may be based on the user model 16, wherein past parking events have created a pattern of the vehicle being parked in less expensive parking spaces, except in the case of inclement weather.

In an exemplary embodiment, the driver interface 18 is adapted to receive information from the driver for more specific parking preferences. For example, the data processor 12 may prompt the driver through the driver interface 18 with a question, such as “You are traveling to the ABC building. Are you in a hurry?”. Wherein, the driver can respond, either verbally or by inputting a response on the driver interface 18, with a “yes”, wherein the data processor 12 will rank closer parking spaces higher, or with a “no”, wherein the data processor 12 will rank parking spaces that are cheaper or more convenient higher, even though they may require the driver to walk a distance to the final destination. In another example, with an autonomous vehicle, the data processor 12 may prompt the driver through the driver interface 18 with a question, such as “Do you wish to be dropped off at the entrance?”, wherein, if the driver chooses, the vehicle will proceed to the entrance of the final destination, and automatically proceed to a nearby parking spot after the driver has exited the vehicle. Such parking spot ranked based on the fact that typical driver preferences, such as distance from the final destination, are less important.

In an exemplary embodiment, the data processor 12 is adapted to update the user model 16 based on inputs collected by the data processor 12, via the driver interface 18, and which one of the plurality of potential parking spaces is ultimately selected. Each time the vehicle is parked, the selected parking space, characteristics of the selected parking space, data from the plurality of sensors 14 within the vehicle and data from the external sources 22 is collected by the data processor 12 and used to update the user model 16. This updating continually improves the predictions made by the user model 16 and allows the user model 16 to evolve as a driver's habits and preferences may change over time.

In an exemplary embodiment, the data processor 12 is adapted to repeat creating the list of potential parking spaces and ranking the potential parking spaces at a pre-determined interval as the vehicle moves toward the destination. As a vehicle nears the final destination, the data processor 12 continually collects data from the external sources 22 and updates the list of ranked parking spaces. For example, a database for a parking structure may be updated to show that the availability of parking spaces in that parking structure has changed, and the data processor 12 can update the list of ranked parking spaces to include recently vacated parking spaces or to remove recently occupied parking spaces. In addition, weather conditions or traffic conditions may change, affecting the ranking of the potential parking spaces. By continually updating the list of ranked parking spaces, the data processor 12 ensures accurate information is being relayed to the driver of the vehicle as the vehicle approaches the final destination.

Referring to FIG. 4, a flowchart illustrating a method 100 of selecting an optimized parking location for a vehicle is shown. Starting at block 102, the method includes collecting, with the data processor 12, parking preferences for a driver of the vehicle. Moving to block 104, the method 100 further includes identifying, with the data processor 12, a destination of the vehicle. Moving to block 106, the method 100 includes identifying, with the data processor 12, a current location of the vehicle. Moving to block 108, the method 100 further includes collecting data, with the data processor 12, from the plurality of sensors 14 within the vehicle, and, moving to block 110, collecting, with the data processor 12, data from external sources 22 and, moving to block 112 creating a list of potential parking spaces.

Moving to block 114, the method 100 further includes accessing, with the data processor 12, the user model 16 based on historical data of parking events for the vehicle, and, moving to block 116, ranking, with the data processor 12, the potential parking spaces based on the parking preferences of the driver, the data from external sources 22 and the user model 16, and, moving to block 118, providing, with the data processor 12, an output based on parking preferences for the driver of the vehicle and the user model 16.

In an exemplary embodiment, the collecting, with the data processor 12, parking preferences for the driver of the vehicle at block 102, further includes collecting, with the data processor 12, via a driver interface 18, one of the first selection preference, the second selection preference and the third selection preference.

Within block 118, moving to block 120, the providing, with the data processor 12, the output based on parking preferences for the driver of the vehicle and the user model 16 further includes, sending, with the data processor 12, instructions to the vehicle controller 24 to automatically park the vehicle in a highest ranked potential parking space when the driver of the vehicle has selected, via the driver interface 18, the first selection preference.

Within block 118, moving to block 122, the providing, with the data processor 12, the output based on parking preferences for the driver of the vehicle and the user model 16 further includes displaying, with the data processor 12, via the driver interface 18, a plurality of ranked potential parking spaces, and, moving to block 124, collecting, with the data processor 12, via the driver interface 18, a selection of one of the ranked potential parking spaces by the driver and a selection of one of automated parking and manual parking.

Moving from block 124 to block 126, the method 100 includes sending, with the data processor 12, instructions to the vehicle controller 24 to automatically park the vehicle in a selected one of the plurality of ranked potential parking spaces when the driver of the vehicle has selected, via the driver interface 18, the second selection preference and automated parking.

Moving from block 124 to block 128, the method 100 includes sending, with the data processor 12, instructions to the vehicle controller 24 to allow the driver of the vehicle to manually park the vehicle in the selected one of the plurality of ranked potential parking spaces when the driver of the vehicle has selected, via the driver interface 18, the second selection preference and manual parking.

Within block 118, moving to block 130, the providing, with the data processor 12, the output based on parking preferences for the driver of the vehicle and the user model 16 further includes displaying, with the data processor 12, via the driver interface 18, the plurality of ranked potential parking spaces when the driver of the vehicle has selected, via the driver interface 18, the third selection preference.

In an exemplary embodiment, the displaying, with the data processor 12, via the driver interface, the plurality of ranked potential parking spaces at blocks 122 and 130, further includes, displaying, with the data processor 12, via the driver interface 18, an explanation of the ranking of the plurality of ranked potential parking spaces.

In another exemplary embodiment, the displaying, with the data processor 12, via the driver interface 18, an explanation of the ranking of the plurality of potential parking spaces at blocks 122 and 130, further includes, displaying, with the data processor 12, via the driver interface 18, a comparison of parking characteristics of each of the plurality of potential parking spaces to user preferences based on parking preferences for the driver of the vehicle, the data from external sources 22 and the user model 16.

Moving to block 132, the method 100 further includes updating, with the data processor 12, the user model 16 based on inputs collected by the data processor 12, via the driver interface 18, and which one of the plurality of potential parking spaces is ultimately selected.

In an exemplary embodiment, the method 100 further includes repeating the creating the list of potential parking spaces at block 112, and the ranking, with the data processor 12, the potential parking spaces based on the parking preferences of the driver and the user model 16 at block 116 at a pre-determined interval as the vehicle moves toward the destination, as indicated by arrow 134 in FIG. 4.

In another exemplary embodiment, the ranking, with the data processor 12, the potential parking spaces based on the parking preferences of the driver, the data from external sources 22 and the user model 16, at block 116, further includes, assigning a value to each one of the potential parking spaces based on how closely each one of the potential parking spaces satisfies the parking preferences of the driver.

In yet another exemplary embodiment, the ranking, with the data processor 12, the potential parking spaces based on the parking preferences of the driver, the data from external sources 22 and the user model 16, at block 116, further includes, calculating a probability that each one of the potential parking spaces will be empty at a time when the vehicle will arrive at such parking space.

A system 10 and method 100 of the present disclosure offers the advantage of selecting an optimal parking space by adapting selection of a parking space to a drivers' preferences and contextual information, interacting with the driver regarding the selection of parking spaces, and explaining the reasoning behind parking space selections. This will allow better driver satisfaction, particularly with automated vehicles, when such vehicle systems select parking spaces.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of selecting an optimized parking location for a vehicle, comprising:
collecting, with a data processor, parking preferences for a driver of the vehicle;
identifying, with the data processor, a destination of the vehicle;
identifying, with the data processor, a current location of the vehicle;
collecting, with the data processor, data from a plurality of sensors within the vehicle;
collecting, with the data processor, data from external sources and creating a list of potential parking spaces;
accessing, with the data processor, a user model based on historical data of parking events for the vehicle;
ranking, with the data processor, the potential parking spaces based on the parking preferences of the driver, the data from external sources and the user model; and
providing, with the data processor, an output based on parking preferences for the driver of the vehicle and the user model.

2. The method of claim 1, wherein the collecting, with the data processor, parking preferences for the driver of the vehicle further includes collecting, with the data processor, via a driver interface, one of a first selection preference, a second selection preference and a third selection preference.

3. The method of claim 2, wherein the providing, with the data processor, the output based on parking preferences for the driver of the vehicle and the user model further includes, sending, with the data processor, instructions to a vehicle controller to automatically park the vehicle in a highest ranked potential parking space when the driver of the vehicle has selected, via the driver interface, the first selection preference.

4. The method of claim 3, wherein the providing, with the data processor, the output based on parking preferences for the driver of the vehicle and the user model further includes:
displaying, with the data processor, via the driver interface, a plurality of ranked potential parking spaces;
collecting, with the data processor, via the driver interface, a selection of one of the ranked potential parking spaces by the driver and a selection of one of automated parking and manual parking; and
sending, with the data processor, instructions to the vehicle controller to automatically park the vehicle in a selected one of the plurality of ranked potential parking spaces when the driver of the vehicle has selected, via the driver interface, the second selection preference and automated parking.

5. The method of claim 4, wherein the providing, with the data processor, the output based on parking preferences for the driver of the vehicle and the user model further includes sending, with the data processor, instructions to the vehicle controller to allow the driver of the vehicle to manually park the vehicle in the selected one of the plurality of ranked potential parking spaces when the driver of the vehicle has selected, via the driver interface, the second selection preference and manual parking.

6. The method of claim 5, wherein the providing, with the data processor, the output based on parking preferences for the driver of the vehicle and the user model further includes displaying, with the data processor, via the driver interface, the plurality of ranked potential parking spaces when the driver of the vehicle has selected, via the driver interface, the third selection preference.

7. The method of claim 6, wherein the displaying, with the data processor, via the driver interface, the plurality of ranked potential parking spaces further includes, displaying, with the data processor, via the driver interface, an explanation of the ranking of the plurality of ranked potential parking spaces.

8. The method of claim 7, wherein the displaying, with the data processor, via the driver interface, an explanation of the ranking of the plurality of potential parking spaces further includes, displaying, with the data processor, via the driver interface, a comparison of parking characteristics of each of the plurality of potential parking spaces to user preferences based on parking preferences for the driver of the vehicle, the data from external sources and the user model.

9. The method of claim 8, further including, updating, with the data processor, the user model based on inputs collected by the data processor, via the driver interface, and which one of the plurality of potential parking spaces is ultimately selected.

10. The method of claim 9, further including, repeating the creating the list of potential parking spaces and the ranking, with the data processor, the potential parking spaces based on the parking preferences of the driver and the user model at a pre-determined interval as the vehicle moves toward the destination.

11. The method of claim 10, wherein the ranking, with the data processor, the potential parking spaces based on the parking preferences of the driver, the data from external sources and the user model further includes, assigning a value to each one of the potential parking spaces based on how closely each one of the potential parking spaces satisfies the parking preferences of the driver.

12. The method of claim 11, wherein the ranking, with the data processor, the potential parking spaces based on the parking preferences of the driver, the data from external sources and the user model further includes, calculating a probability that each one of the potential parking spaces will be empty at a time when the vehicle will arrive at such parking space.

13. A system for selecting an optimized parking location for a vehicle, comprising:
a data processor;
a plurality of sensors within the vehicle; and
a user model based on historical data of parking events for the vehicle;
the data processor adapted to:
collect parking preferences for a driver of the vehicle;
identify a destination of the vehicle;
identify a current location of the vehicle;
collect data from a plurality of sensors within the vehicle;
collect data from external sources and create a list of potential parking spaces;
access the user model;
rank the potential parking spaces based on the parking preferences of the driver, the data from external sources and the user model; and
provide an output based on parking preferences for the driver of the vehicle and the user model.

14. The system of claim 13, further including a driver interface, wherein the data processor is adapted to collect parking preferences for the driver of the vehicle via the driver interface, the parking preferences being one of a first selection preference, a second selection preference and a third selection preference.

15. The system of claim 14, further including a vehicle controller, wherein, when the driver of the vehicle has selected the first selection preference, the output provided by the data processor comprises instructions, sent to the vehicle controller, to automatically park the vehicle in a highest ranked potential parking space.

16. The system of claim 15, wherein the data processor is further adapted to:
display, via the driver interface, a plurality of ranked potential parking spaces; and
collect, via the driver interface, a selection of one of the ranked potential parking spaces by the driver and a selection of one of automated parking and manual parking;
wherein, when the driver of the vehicle has selected the second selection preference and automated parking, the output provided by the data processor comprises sending instructions to the vehicle controller to automatically park the vehicle in a selected one of the plurality of ranked potential parking spaces;
when the driver of the vehicle has selected the second selection preference and manual parking, the output provided by the data processor comprises sending instructions to the vehicle controller to allow the driver of the vehicle to manually park the vehicle in the selected one of the plurality of ranked potential parking spaces; and
when the driver of the vehicle has selected the third selection preference, the output provided by the data processor comprises displaying, via the driver interface, the plurality of ranked potential parking spaces.

17. The system of claim 16, wherein the data processor is further adapted to display, via the driver interface, an explanation of the ranking of the plurality of ranked potential parking spaces by displaying a comparison of parking characteristics of each of the plurality of potential parking spaces to user preferences based on parking preferences for the driver of the vehicle, the data from external sources and the user model.

18. The system of claim 17, wherein the data processor is adapted to update the user model based on inputs collected by the data processor, via the driver interface, and which one of the plurality of potential parking spaces is ultimately selected.

19. The system of claim 18, wherein the data processor is adapted to repeat creating the list of potential parking spaces and ranking the potential parking spaces at a pre-determined interval as the vehicle moves toward the destination.

20. The system of claim 19, wherein the data processor is adapted to rank the potential parking spaces based on the parking preferences of the driver, the data from external sources and the user model by:
assigning a value to each one of the potential parking spaces based on how closely each one of the potential parking spaces satisfies the parking preferences of the driver; and
calculating a probability that each one of the potential parking spaces will be empty at a time when the vehicle will arrive at such parking space.
